(19) United States
(12) Patent Application Publication
(10) Pub. No.: US 2005/0067139 A1
(43) Pub. Date: Mar. 31, 2005

(54) Evaporator core seal

(75) Inventor: Calin Marginean, Lake Orion, MI (US)

Correspondence Address: Valeo Climate Control Corp;Intellectual Property Dept, 4100 North Atlantic Boulevard, Aubum Hills, MI, 48326, US

(73) Assignee: Valeo Climate Control Corp

(21) Appl. No.: 10/722,952

(22) Filed: Nov. 26, 2003

Related U.S. Application Data
(60) Provisional application No. 60/507,181, filed on Sep. 30, 2003.

(51) Int. Cl. B60H 3/00

(52) U.S. Cl. 165/42; 165/43; 62/272

(57) ABSTRACT

The present invention relates to a means of providing that air flows to the appropriate areas to allow for maximum cooling in such a system, by providing for a means for preventing air bypass around certain cores, such as an evaporator core, in an automotive air conditioning application. The simplified HVAC unit provides, without use of wraps, foam or polyethylene seals and the like, a means for greatly decreasing or preventing air from bypassing the evaporator core which is easy to install and requires less tooling, thereby increasing efficiency while providing for easier assembly and lower odor production by eliminating such wraps, foams or seals and the like.

### FIELD OF THE INVENTION

The present invention relates generally to an airflow control in heating and air conditioning units, particularly for automotive purposes.

### BACKGROUND OF THE INVENTION

The present invention relates to the field of directing ventilating air and airflow control in a ventilating, heating or air conditioning system. More specifically, the present invention relates to a means of providing that air flows to the appropriate areas to allow for maximum cooling in such a system, by providing for a means for preventing air bypass around certain cores, such as an evaporator core, in an automotive air conditioning application.

### DESCRIPTION OF THE PRIOR ART

In automotive ventilating systems and in ventilating systems in general, air needs to be directed to desired areas and pass through respective air passageways. Prior to entering into air outlet means such as dampers, doors and various mechanisms, the system must be designed so that the maximum of air reaches the heating or cooling heat exchanger locations prior to being released into the vehicle cockpit or compartments. For example, in a vehicle it is often desired to air enter the vehicle and then be circulated through a circuit in the HVAC unit. Likewise, a design may provide for air to circulate around a circuit so that it provides heated or cooled air which they may pass through an area or zone where it mixes to provide a certain temperature of air based on the area in the passenger compartment of a vehicle to which the air will be finally directed.

Ventilating, heating and air conditioning systems in modern vehicles strive to provide a total interior climate control. Such systems maintain a desired temperature by delivering an appropriate mix of ambient, cooled and heated air to the vehicle interior. A further desired goal of such systems is to provide for the maximum heat loss or gain in the system prior to being directed to the area or zone of mixing and prior to reaching the passenger compartment to which it will be finally selected. Such operation requires the operation of the vehicle HVAC system wherein the car is heated or cooled or left stable so that the ambient, cooled and/or heated air can be mixed to provide an air temperature for distribution desired for the selected areas of the vehicle. It is clear that any ventilation system, including air conditioning or heating system, must have functional characteristics such that when being heated or cooled, the air remains in close proximity to the heating and/or cooling elements or cores, so as to maximize the amount of heat transfer that occurs in these areas. However, there have always been problems with finding means to prevent air bypass or escape around cores, and, specifically, evaporator cores in air conditioning units, which have required means such as foam or polyethylene sealings or glues to prevent such air bypass or premature release or escape from the heat exchanger core region.

In view of the drawbacks and disadvantages identified in the prior art, it is an object of the present invention to provide a simpler and more reliable means for preventing bypass, premature release or escape of air flowing around a heat exchanger core prior to it arriving to its mixing zone for eventual distribution to the passenger compartment. The present invention, particularly in its preferred embodiments, solves the problem of the foam or polyethylene seals or glues, or wraps around the evaporator core that are found in the prior art. By providing for increased volumes of air in close proximity or which pass over the evaporator core, the present invention increases the efficiency and allows additional cooling effect to achieve adequate passenger compartment comfort, as well as simplifying and reducing the overall cost of the system. In addition, in preferred embodiments, the present invention allows for a system that the potential odor related to air conditioning, and in particular, automotive HVAC systems, by reducing the area of contact and/or use of materials where microbial or other growth might occur. The preferred embodiments of the present invention also reduced the amount of assembly and, thereby, decrease the costs, over systems that employ other means to seal, glue or wrap around the heat exchanger, and, in particular, evaporator, core.

The present invention also provides a method of providing a ‘cap’ or ‘lining’ which may, unlike the other sealing methods hereindescribed, by design, be adjusted to compensate for tolerance variation and the like.

### SUMMARY OF THE INVENTION

The present invention meets the above needs by providing an air distribution module for a vehicle heating, ventilation and air conditioning system wherein said module receives airflow of air which passes in close proximity or over a heat exchanger in an air conditioning unit. The air distribution module preferably further comprises a heat exchanger such as a evaporator or evaporator means and/or a heater or heater means, more preferably a evaporator or heater core or the like, most preferably a evaporator core.

In particular, the present invention relates to a means for preventing bypass, premature release or escape of air around a heat exchanger or heat exchanger core wherein less air by volume bypasses, is prematurely released or escapes without passing in close proximity or over the heat exchanger, thereby increasing the total passage of said air in close proximity or over the heat exchanger, leading to more efficient heat transfer potential of said passage.

In a preferred embodiments of the present invention, the air conditioning system or HVAC is one suitable for use in automotive applications. Even more preferred are embodiments wherein the heat exchanger is an evaporator core. Even more preferred are embodiments wherein the evaporator core is positioned to be within a ‘cap’ or ‘liner’ which prevents the escape or otherwise prevents air from bypassing the evaporator core. Even more preferred are caps or liners wherein the caps or liners are made of materials allowing for compensation for temperature and vibration tolerances or spring like effects; most preferred are plastic or plastic like cap or liner materials.

In addition, most preferably, the air passes in close proximity or over the evaporator means prior to entering into a chamber or chambers prior to distribution within an automotive vehicle. Also preferred is an air distribution module wherein the airflow flows in line throughout the module, more preferred while flowing in line by the outlet means passing by means after mixing to the front and rear passenger areas. Also preferred is an air distribution module for a vehicle heating, ventilation and air conditioning system wherein the air of the airflow is mixed in the single chamber prior to distribution to the front and rear passenger and defrost areas of a vehicle interior. Further preferred embodiments of the present invention have modules that further comprise a evaporator means and heater means, even further preferred modules provide a method for providing for air to pass by the evaporator means or the heater means prior to entering into the single chamber. In another preferred embodiment the air does not pass by said evaporator means. In another preferred embodiment, the air passes only by the heater means prior to distribution to the defrost area. In a further preferred embodiment, the airflow flows in line after mixing to the front and rear passenger and defrost areas. In other preferred embodiments, the liner further comprises at least one drain, hole, vent slot or other perforation (slot); more preferably, a number of drain slots.

### BRIEF DESCRIPTION OF THE DRAWINGS

The features and inventive aspects of the present invention will become more apparent upon reading the following detailed description, claims, and drawings, of which the following is a brief description:

FIG. 1 is an elevational schematic view of an exemplary prior art heater/evaporator unit housing body for use in motor vehicles;

FIG. 2 is an elevational cross sectional view of exemplary HVAC with lined evaporator core housing in accordance with an aspect of the present invention

FIG. 3 is a schematic cross sectional view of an exemplary HVAC with drain slots in accordance with an aspect of the present invention.

### DETAILED DESCRIPTION OF THE PREFERRED EMBODIMENT

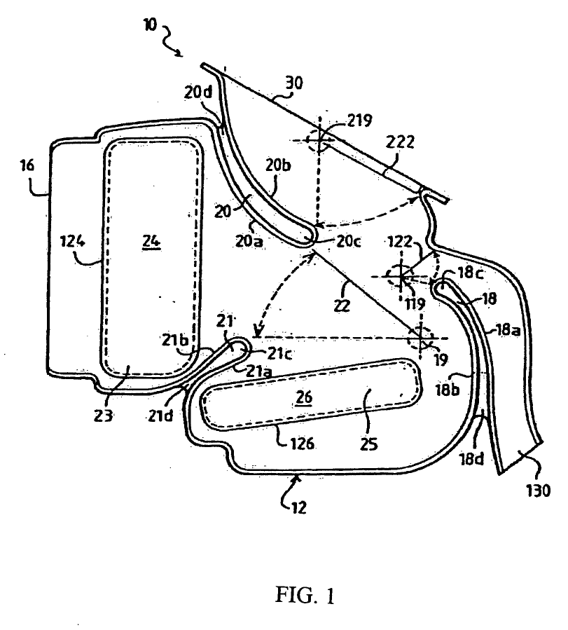

Referring to FIG. 1, there is illustrated a heater unit 10 with a plastics material housing body 12. Fresh air enters the heater unit 10 through an inlet opening 16, and is guided (in part) by internal walls 18, 20, 21 formed integrally with the housing body 12 to one or both of two outlets 30,130. The air entering the heater unit 10 is first dried by passing through an evaporator 24 shown in dashed outline, and is subsequently directed by a pivoting main door 22 either to a heater 26 shown in dashed outline, or directly to one of the outlet openings 30,130, depending on the position of the main door 22. Other outlet section doors 122,222 are used to select one or both of the two outlets 30,130.

The shape of the air chamber within the heater unit 10 is defined by the internal walls of the heater unit 12, the locations of the inlet and outlets openings 16, 30,130 and the positions of the pivoting doors 22,122,222. The housing body has on one or both sides two apertures 124,126 to allow for respectively the evaporator 24 and the heater 26 to be inserted into the housing body. Each door 22,122,222 has a pivot axle 19,119,219 that runs through openings in the housing body 12. Each pivot axle 19,119,219 is able to rotate between bearings on a structural frame in order allow the door to pivot. The internal walls 18, 20, 21 each have two surfaces, denoted with the suffix a or b respectively. The surfaces do not touch each other and in this example the walls are hollow, the gap within each wall being denoted by the suffix c.

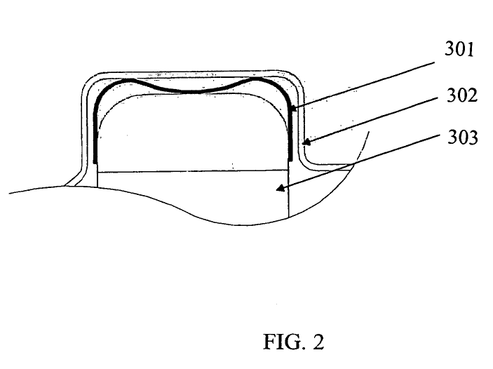

FIG. 2 is a non-limiting preferred embodiment of the present invention and shows a line 301 made of a plastic material achieved with a single mold inside an HVAC housing 302 and no further assembly required. The shape of the liner, in conjunction with the elasticity of the material, allows for compensation for evaporator core 303 tolerance or spring like effect. The spring like effect prevents rattle and positions the evaporator core firmly in place.

The cap or liner may be of any material with appropriate elasticity and temperature characteristics that allow for ‘compensation’ or ‘give’ for the evaporator core ‘tolerances’ or ‘spring-like effects.’ The spring like effect prevents ‘rattle’ or vibration that might lead to inappropriate or malpositioning of the evaporator core in the HVAC assembly, leading to decreased efficiency and air passage in its function. Particularly preferred are materials comprising plastic of plastic like materials, more particularly thermal stable or otherwise thermal resistant plastics and plastic like materials, that retain acceptable characteristics with changes in temperature and pressure conditions found with in the HVAC unit which may be placed with the housing of the HVAC unit, and, particularly, around the evaporator core.

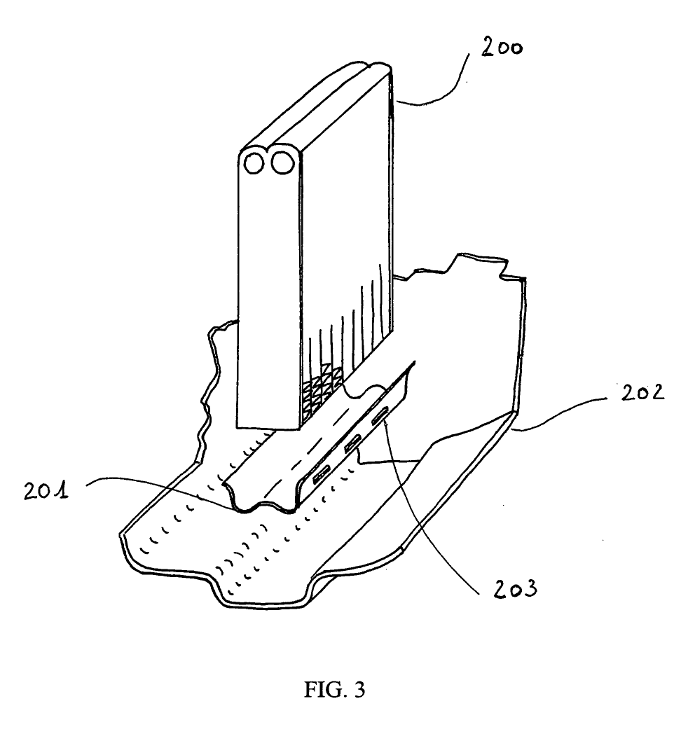

In FIG. 3, a non limiting preferred embodiment of the present invention includes an evaporator (200), plastic liner (201), HVAC housing (202), and drain slots (203). The evaporator (200) exchanges heat between a cooler fluid media and a warmer air media. Humidity consensed out of the air collects on the outer surface of the evaporator (200) and falls to the bottom of the evaporator and into the drain in the housing.

As described herein, the plastic liner (201) essentially prevents air from bypassing the evaporator. The HVAC housing (202), is, preferably, of a structure that forms a boundary or boundaries which direct air through the HVAC module or evaporator. Drain slots (203) in the plastic liner allow water to pass to the drain.

In a preferred embodiment of the present invention, the air distribution module for a vehicle heating, ventilation and air conditioning system wherein said module receives an airflow of air comprises a housing; an heat exchanger means; and a chamber within the housing for reception of the air flow. The majority of air of the airflow is prevented from bypassing, prematurely being released or escaping prior to passing by or over the heat exchanger means by a cap or liner positioned around the heat exchanger core. In a more preferred embodiment, the heat exchanger means comprises an evaporator means and heater means. Even more preferred are embodiments wherein heat exchanger means is a evaporator core.

In particularly preferred embodiments of the present invention, the air distribution module for a vehicle heating, ventilation and air conditioning system wherein said module receives an airflow of air comprises: a housing; an evaporator core; a cap or liner; and a chamber within the housing for reception of the air flow.

In preferred embodiments of the present invention, the cap or liner is a plastic or plastic like material; even more preferred are wherein the plastic material is elastic and is molded in a single mold inside the housing. Additional more preferred embodiments include those wherein the air of the airflow is mixed in a chamber prior to distribution to the front and rear passenger and defrost areas of a vehicle; even more preferred are embodiments wherein the majority of air in the air flow passes by the evaporator core prior to distribution entry into the chamber for eventual distribution to the front and rear passenger and defrost areas of a vehicle.

In preferred embodiments, it is also possible to employ ‘projections’ or ‘ribs, often referred to as crash ribs, that are between the housing and liner or cap of the present invention. In such embodiments, the crash ribs are more preferably attached to the housing of the HVAC. Even more preferred are crash ribs which are thin. Also more preferred are crash ribs that allow slight deformation during assembly, thereby accommodating for variation in evaporator core dimensions that might exist in different HVAC units.

1. A air distribution module for a vehicle heating, ventilation and air conditioning system wherein said module receives an airflow of air comprising:
a housing;
an heat exchanger means;
a chamber within the housing for reception of the air flow;
wherein the majority of air of the airflow is prevented from bypassing, prematurely being released or escaping prior to passing by or over the heat exchanger means by a cap or liner positioned around the heat exchanger core.

2. An air distribution module according to claim 1 wherein said heat exchanger means comprises an evaporator means and heater means.

3. An air distribution module according to claim 1 wherein said heat exchanger means is a evaporator core.

4. An air distribution module for a vehicle heating, ventilation and air conditioning system wherein said module receives an airflow of air comprising:
a housing;
an evaporator core;
a cap or liner;
a chamber within the housing for reception of the air flow.

5. An air distribution module according to claim 4 wherein the cap or liner is a plastic or plastic like material.

6. An air distribution module according to claim 5 wherein the plastic material is elastic and is molded in a single mold inside the housing.

7. An air distribution module according to claim 4 wherein the air of the airflow is mixed in a single chamber prior to distribution to the front and rear passenger and defrost areas of a vehicle.

8. An air distribution module according to claim 4 wherein the air of the majority of air in the air flow passes by the evaporator core prior to distribution entry into the chamber for eventual distribution to the front and rear passenger and defrost areas of a vehicle.

9. An air distribution module according to claim 4 further comprising crash ribs between the housing and liner or cap.

10. An air distribution module according to claim 1, wherein the cap or liner further comprises at least one drain slot.

11. An air distribution module according to claim 6, wherein the cap or liner further comprises at least one drain slot.
